(19) United States
(12) Patent Application Publication
(10) Pub. No.: US 2017/0083885 A1
(43) Pub. Date: Mar. 23, 2017

(54) AUTOMATED DRY CLEANING AND LAUNDRY SERVICE KIOSK

(71) Applicant: Kabin Khadgi, Jackson Heights, NY (US)

(72) Inventor: Kabin Khadgi, Jackson Heights, NY (US)

(21) Appl. No.: 14/860,819

(22) Filed: Sep. 22, 2015

(51) Int. Cl. G06Q 20/18; G06Q 20/20

(52) U.S. Cl. CPC G06Q 20/18; G06Q 20/208

(57) ABSTRACT

A method and system for providing automated dry cleaning and laundry service using a kiosk is provided. The method and system additionally makes use of an interactive point-of-sale subsystem housed within the kiosk. A laundry unit container for housing items to be laundered also serves as a dry cleaning/laundry unit pick-up container for delivering laundered items to the customer is also housed within the kiosk. The laundry station is used: to receive and accept orders for laundry services from a customer, including the collection of payment from the customer and provide information directing the customer to place their dry cleaning/laundry in kiosk; and to generate and communicate an electronic message to instruct the customer to pick-up their order upon completion at the same laundry unit pick-up container housed in the same kiosk were they initially placed there items to be laundered.

### FIELD OF THE INVENTION

The present invention relates in general to a method and system for providing dry cleaning and laundry services. More particularly, the present invention relates to a method and system for providing automated dry cleaning and laundry services that makes use of a dry cleaning/laundry service kiosk.

### BACKGROUND OF THE INVENTION

Laundry and dry cleaning services are found throughout the United States and in foreign countries where commercial laundry and dry cleaning services are provided to the retail public. All segments of the adult population utilize these services to varying degrees. Indeed, a number of working adults, students, and retirees commonly avail themselves of these services as a means of avoiding doing the laundering tasks themselves. Typically, laundry services are done so a customer bringing their laundry to their dry cleaners to be serviced and then returning to pick-up their dry cleaning order at an expected completion time.

However, for those customers that choose not to visit the dry cleaners, their laundry orders may still be facilitated through a traditional pick-up and delivery process. However, there currently exist several logistical challenges using this method such as justifying the cost of using a vehicle and driver. In most cases, the laundry service charge is based on the weight of the order, and will thus vary depending upon the amount of items or garments needing to be serviced. This variance in the amount of clothes needing to be laundered frequently causes the traditional pick-up and delivery process to be economically prohibitive for some laundry service provider wherein they need to charge a minimum for their laundry services, regardless of the weight of the order. However, even when laundry service providers charge a minimum price, it is still the case that laundry orders that are processed via the traditional pick-up and delivery process must still be weighed at the time of pick-up or upon returning to the laundromat, and thus still require an extra step for the laundry service provider.

Moreover, many laundry service providers avoid the traditional pick-up and delivery laundry processes, because of the great dispersion of customer locations and because of the variables that are associated with synchronizing pick-up and delivery times with the customers in order to facilitate the process itself as well as payment by the customers. Typically, payment for laundry services occurs either at the time of the pick-up of the order, if the customer is available, or afterward. However, this process is grossly inefficient as it requires either the driver facilitating the pick-up of the order to also function as a cashier for the transaction, or it requires the laundry service provider to develop a billing system and procedure that monitors the accounts for the picked up but unpaid transactions.

Accordingly, a new method and system for providing dry cleaning and laundry services that does not rely on the customer traveling to a laundry service provider to bring their soiled laundry for servicing and then returning to pick-up their completed order would be highly convenient and potentially desirable to all customer segments taking advantage of the service.

### SUMMARY OF THE INVENTION

A method and system for providing automated dry cleaning and laundry service kiosk is provided. The method and system makes use of the dry cleaning and laundry kiosk by having an interactive point-of-sale subsystem including a laundry unit container for housing items to be laundered that also serves as a dry cleaning/laundry unit pick-up container for delivering laundered items to the customer. More specifically, the laundry station is used: to receive and accept orders for laundry services from a customer, including the collection of payment from the customer; to provide information directing the customer to place their dry cleaning/laundry in an internally housed laundry unit placement container in response to the order received from the customer; to generate and communicate an electronic message to instruct a laundry station operator or laundry services provider to fulfill the order and to generate and communicate an electronic message to instruct the customer to pick-up their order upon completion at the same laundry unit pick-up container housed in the same kiosk were they initially placed there items to be laundered. Additionally, the laundry unit placement container housed within the laundry service kiosk may also package the items initially placed by the customer by weighing or counting the garment pieces and stores each customer order in individual bags which are then vacuumed pressed with a marked label for identification purposes.

### DESCRIPTION OF THE DRAWINGS

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention. In the accompanying drawings:

FIG. 1 is a perspective view of a laundry kiosk in accordance with the present invention;

FIG. 2 is a system block diagram illustrating the different components for the laundry kiosk for providing laundry services in accordance with the present invention.

FIG. 3 is a flow chart illustrating the steps to implement a method for providing laundry services using the laundry kiosk in accordance with the present invention.

FIG. 4 is a continuation of the flow chart of FIG. 3 further illustrating the steps to implement a method for providing laundry services using the laundry kiosk in accordance with the present invention.

### DESCRIPTION OF EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Reference will now be made in detail to embodiments, methods and systems of the present invention known to the inventor. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

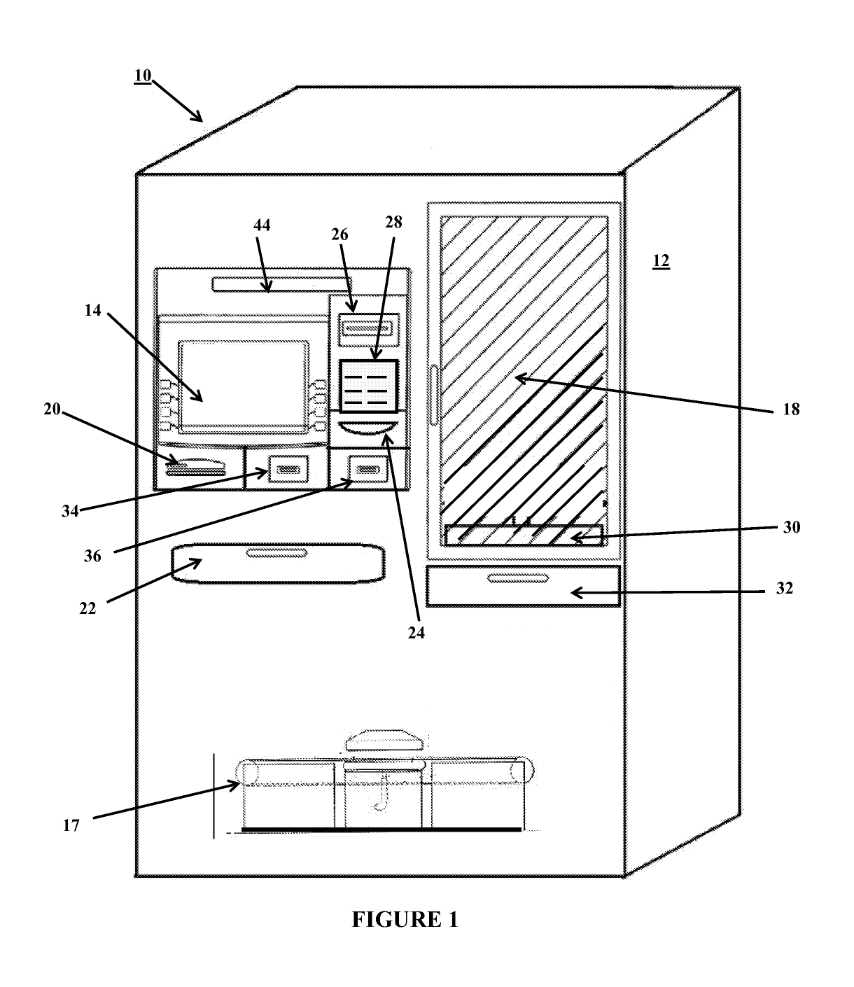

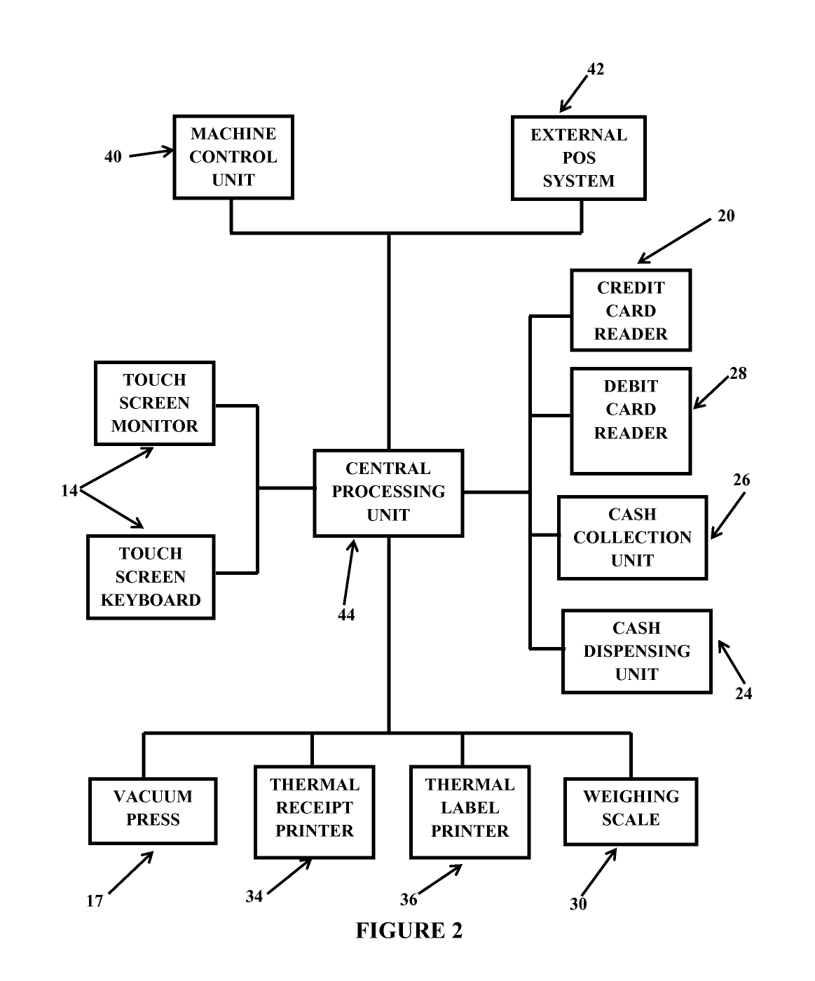

In accordance with the present invention, methods and systems for providing dry cleaning and laundry services are provided. Referring now to FIGS. 1 and 2, there is shown a laundry kiosk 10 is a generally rectangular or square shaped housing 12 and a system block diagram illustrating the different components of the laundry kiosk 10 for providing laundry services in accordance with the present invention. As shown in the figures, the laundry kiosk 10 uses an interactive point-of-sale subsystem and internally houses a laundry unit placement and pick-up container 18 for packaging and storing items to be laundered and/or picked-by the customer. The laundry kiosk 10 is used: to receive and accept orders for laundry services from a customer, including the collection of payment from the customer; to provide information directing the customer to place their laundry in an internally housed laundry unit placement container 18 in response to the order received from the customer; to generate and communicate an electronic message to instruct a laundry station operator or laundry services provider to fulfill the order and to generate and communicate an electronic message to instruct the customer to pick-up their order upon completion at the same laundry unit pick-up container 18 housed in the same kiosk 10 were they initially placed there items to be laundered. Additionally, the laundry unit placement container 18 housed within the laundry service kiosk 10 may package the items initially placed by the customer by weighing or counting 30 the garment pieces (customer will be asked to enter quantity). Weight will be done by a machine calculation that also stores each customer order in individual bags housed in compartment 32 for which the laundry items may be placed which are then internally vacuumed pressed 17, tagged with a marked label 36 for identification purposes.

In a preferred embodiment, the laundry service kiosk 10 includes an interactive point-of-sale subsystem operably connected to the internally housed laundry unit container 18, respectively used for receiving and delivering laundry items 18 or for delivery or pick-up. The interactive point-of-sale subsystem includes a micro-computer 44 and a touch screen display 14 to facilitate the use of the laundry service kiosk 10 without the assistance of an attendant. In this regard, the interactive point-of-sale subsystem further includes a payment credit or debit card reader 20 and an ATM machine key pad 28 where customer is asked to enter debit card pin and a thermal receipt printer 34 operably connected to the micro-computer 44 used by the interactive point-of-sale subsystem such that payment information may be collected and processed wherein either a printed or electronic receipt 34 may be provided to the customer at the same time that the customer orders his or her laundry services. More specifically, the interactive point-of-sale subsystem includes the hardware and software necessary to carry out the receipt and acceptance of an order for laundry services from a customer, including the collection of payment information from the customer. The payment information is then processed by using a payment processing software application executed by the micro-computer 44 and is typically requested in the form of a card having a magnetic strip, such as a credit or debit card, which is then read using the card reader 20 or alternatively accept hard currency using cash collection unit 26.

Once the payment information has been collected and processed, the interactive point-of-sale subsystem then prompts the customer to create and establish a personalized pass code for allowing access to the internally housed laundry unit placement container. After the payment information has been verified a garment drop-off window 18 opens allowing the customer to place their items in for weighing or counting 30 (weight or quantity or both is measured before payment processing, since weight is important component for determining total charges) the garment pieces for each customer order are stored in individual bags (not shown) in compartment 22 wherein the bags containing the garment are now placed in drop off container 18 or laundry unit placement container 18 within the laundry service kiosk 10. The laundry unit placement container 18 then packages the items initially placed by the customer by which are then vacuumed pressed and tagged with a marked label for identification purposes and to assist in later notifying the customer that their laundry service order has been fulfilled. For example, the customer identifying information can include an email address and/or a telephone number such that the customer can later be contacted via an email message or, text message call and notified that the to their mobile phone that their order has been fulfilled.

Once the items to be laundered have been placed in the laundry unit placement container 18, the interactive point-of-sale subsystem receives a signal from the laundry unit placement container 18 that it is occupied and prints a receipt 34 for the customer, which includes the total charge for the laundry services. Upon the receipt of a signal from the laundry unit placement container 18 that it is occupied by items to be laundered, the interactive point-of-sale subsystem then generates an electronic message to instruct a laundry services provider to retrieve the items to be laundered from the laundry unit placement container 18 and, subsequent to completing the order, return the laundered items to the laundry unit pick-up container housed within the same kiosk 10.

Upon return of the laundered items, the interactive point-of-sale subsystem transmits an electronic message to the customer, such as an email or text message, to notify the customer of the fulfillment of the order. The customer then goes back to the laundry kiosk 10, enters their personalized code (customer credentials or credit card swipe) and retrieves their laundered items from the laundry unit pick-up container. After the removal of the laundered items by the customer (from window 18), the interactive point-of-sale subsystem then generates a second electronic message to notify the laundry services provider that the laundered items have been retrieved by the customer.

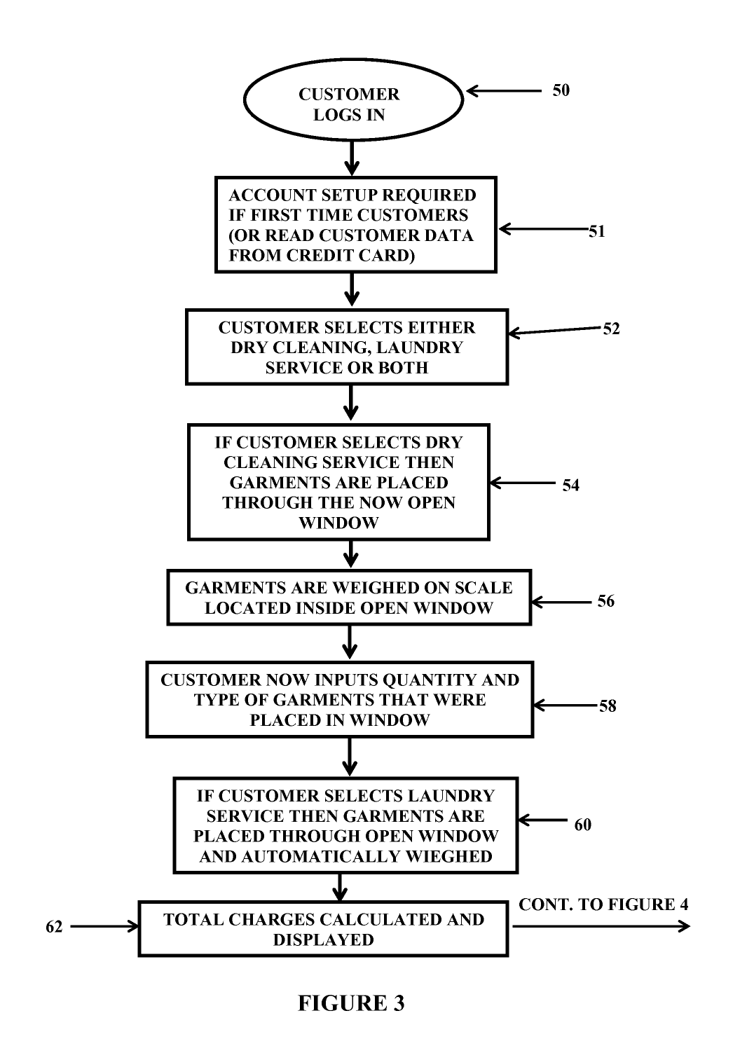

Referring now to FIG. 3 there is shown a flowchart describing the method steps in accordance with the present invention of using a kiosk 10. Initially the customer logs in as shown in step 50. Next in step 51, if account setup is required for first time customers, the first time customer inputs there data or inserts their credit card wherein customer data may be collected and stored. The customer now using touch screen display 14 selects the type of service they desire whether it is dry cleaning, laundry or a combination of both in step 52. The customer is then directed in step 54 to place their garments through window 18 which has now opened up onto garment place surface 30. The garment place surface 30 interiorly houses a scale where the customer garments (not shown) will be weighed in step 56. If the customer chooses dry cleaning in step 58, the customer will be asked to select the type of garments, quantity etc. If the customer chooses laundry service in step 60, the weight of the garments will be done automatically once the customer places the garment on the scale 30 inside window 18. Based on type of service chosen and garment pieces or laundry weight, the on board touch screen display 14 will display the total charges in details in step 62.

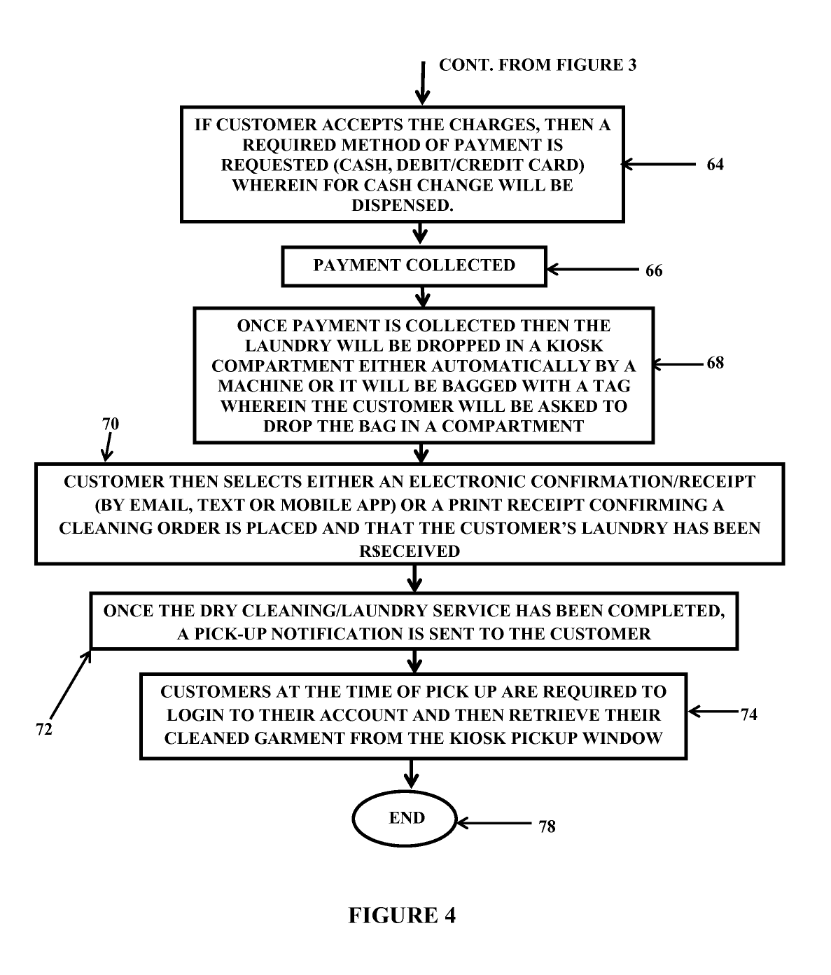

Referring now to FIG. 4 there is shown a continuation of the flowchart of FIG. 3 further describing the method steps in accordance with the present invention of using a kiosk 10. If Customer accepts the charges in step 64 then a require method of payment will be asked (Cash, Debit/credit card) wherein for cash change will be dispensed. Once payment is collected in step 66 then laundry will be drop in compartment either automatically by machine or it will be bagged with tag then customer will be asked to drop in compartment 18 where openings will be done as shown in step 68. Once these steps complete in step 70 then a confirmation email, text or a physical copy of the receipt will be printed at the request of the customer. Customer will have access to mobile application. Once service gets completed in step 72, a notification (email or text or notification in app) will be sent so that customer can pick up their clean garments. The Customer logs in (manually or swipes a credit card which then prompts security code verifications) for pick up wherein the garment will be dispensed for pick-up at window 18, thereby ending the service at step 78.

One of ordinary skill in the art will recognize that additional embodiments are also possible without departing from the teachings of the presently-disclosed subject matter. This detailed description, and particularly the specific details of the exemplary embodiments disclosed herein, is given primarily for clarity of understanding, and no unnecessary limitations are to understood therefrom, for modifications will become apparent to those skilled in the art upon reading this disclosure and may be made without departing from the spirit or scope of the presently-disclosed subject matter.

What is claimed is:

1. A method for providing dry cleaning and laundry services to a customer, comprising:
Providing a laundry station kiosk having an interactive point-of-sale device, wherein said laundry station kiosk houses a laundry unit placement and pick-up container for receiving and delivering garment items in response to the customer dropping off the garments, requesting the service and making a payment.

2. The method according to claim 1 wherein said dry cleaning and laundry station kiosk is used to receive and accept orders for dry cleaning and laundry services from a customer, including the collection of payment from the customer based on said garment weight and the number of garments.

3. The method according to claim 1 wherein said dry cleaning and laundry station kiosk is used to provide information directing the customer to place their laundry in an internally housed laundry unit placement container in response to the order received from the customer wherein a container door is automatically opened at the direction of said interactive point-of-sale device.

4. The method according to claim 1 wherein said dry cleaning and laundry station kiosk is used to generate and communicate an electronic message to instruct a laundry station operator or laundry services provider to fulfill the order.

5. The method according to claim 1 wherein said dry cleaning and laundry station kiosk is used to generate and communicate an electronic message to instruct the customer to pick-up their order upon completion at a laundry unit pick-up container housed in the same kiosk were they initially placed there items to be laundered.

6. The method according to claim 3 wherein said laundry unit placement container housed within the laundry service kiosk packages the items initially placed by the customer by weighing or counting the garment pieces and stores each customer order in individual bags which are then vacuumed pressed with a marked label tagged for identification purposes.
